(19) United States
(12) Patent Application Publication
(10) Pub. No.: US 2008/0233012 A1
(43) Pub. Date: Sep. 25, 2008

(54) Method for preventing repeat use of disposable articles in analyzers

(75) Inventor: Norbert Zander, Marburg (DE)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: DADE BEHRING MARBURG GmbH

(21) Appl. No.: 12/076,620

(22) Filed: Mar. 20, 2008

(30) Foreign Application Priority Data
Mar. 21, 2007 (DE) 10 2007 014 083.7

(51) Int. Cl. B01L 11/00; G01N 1/00

(52) U.S. Cl. 422/99; 73/863.01

(57) ABSTRACT

The invention concerns the field of automatic analysis instruments (analyzers) and relates to a method for preventing repeat use of disposable articles in analyzers.

The invention concerns the field of automatic analysis instruments (analyzers) and relates to a method for preventing repeat use of disposable articles in analyzers.

Automatic analyzers allow a method for qualitative or quantitative determination of an analyte in a sample to be carried out in a substantially automatic manner. Many of these analyzers are able to perform different methods simultaneously or in succession. For this purpose, modern analyzers have various components for carrying out individual method steps, for example devices for receiving and storing vessels that contain the samples to be tested, and devices for removing sample aliquots and for transferring these aliquots to a reaction vessel. These analyzers also usually comprise devices for receiving and storing reagent vessels that contain the necessary reagents, and devices for removing a reagent volume and for transferring this reagent volume to a reaction vessel. After the sample has been mixed with the reagent or the reagents in the reagent vessel, a physical signal is then usually measured that correlates with the quality or quantity of the analyte in the sample. Depending on the nature of the physical signal, an analyzer has appropriate measuring means, for example a photometer, pH meter, dosimeter, luminometer, fluorimeter or the like.

Many automatic analyzers have various transport devices, for example rotatable plates on which the various reagents are arranged, or linear conveyor means which, for example, convey the reaction vessels from a first position, in which the sample is aliquoted, to a second position, in which the reagent is added, and then to a third position, in which the measurement is carried out. The smooth running of all of these method steps is normally controlled by specially developed software. After completion of the test method, the used reaction vessels are often collected in a waste container which, finally, can be emptied by an operator.

Such analyzers also usually comprise devices for identifying the samples and for associating the analysis results with the respective sample. For this purpose, barcode markings are often used that are applied to the outside of each sample vessel and are read by means of a barcode reader.

Many manufacturers of automatic analyzers recommend the exclusive use of special reaction vessels. Particularly when the optical property of a reaction mix is to be analyzed, or when sensitive biochemical test methods are to be carried out, it must be ensured that the nature of the reaction vessels does not disadvantageously affect the test method.

Examples of reaction vessels whose nature is crucial to the quality of the method in which they are used are, for instance, transparent measuring cells such as cuvettes, cuvette rotors or microtitration plates, which are used in an optical detection method. Test methods for determining clinically relevant parameters, for example for diagnosis of clotting parameters, are often evaluated with the aid of photometric detection systems. In the clinical laboratory, fully automatic analyzers are mainly used that permit not only the automatic performance of the test methods, but also the determination of standardized test results. To ensure that the automated methods deliver reliable test results, it is necessary for all the individual components relevant to the test to satisfy specific requirements set by the manufacturer and to be in the state that is absolutely essential for their use. This also includes, among other things, the reaction vessels or measuring cells used, for example cuvettes, cuvette rotors or microtitration plates, in which the analytical samples whose optical property is to be determined are located. Generally, the reaction vessels recommended by the manufacturer not only have specific design features, such as shape, size, layer thickness, etc., but are usually made of a material that exhibits little or no absorption in the spectral range used. Reaction vessels are generally made of plastic, in particular of a plastic from the group comprising polypropylene, polystyrene, polyethylene and polyethylene terephthalate. When other reaction vessel models are used, of which the user is perhaps not even aware, there is a danger that differences in the nature of the material will lead to important deviations or errors in the measurement of, for example, the turbidity or scattered light. A further risk is posed by reaction vessels which, because of their material properties, interact with the analyte to be tested, with the sample or with the reaction mix. This problem is particularly pronounced, for example, in methods used for diagnosis of clotting: if the surface of the reaction vessel or of the measuring cell coming into contact with the reaction mix is such that there is an uncontrolled activation of clotting, it is not possible to reliably determine the clotting reaction. The same danger arises in the repeat use of what are called disposable cuvettes, that is to say reaction vessels that are intended by the manufacturer for single use. Impurities that remain due to inadequate cleaning after the initial use can likewise lead to deviations or measurement errors. Erroneous measurement results, caused by using unsuitable or contaminated reaction vessels, can ultimately lead to incorrect diagnoses which, in the worst case scenario, may have serious health implications for the patients concerned.

The object of the present invention was therefore to develop a method for an automatic analyzer, said method, on the one hand, permitting identification of a disposable article intended for use in the automatic analyzer and, on the other hand, ensuring that this disposable article is also used for its intended purpose just once, and not repeatedly.

The object is achieved by the fact that the disposable article, which is provided with a detectable marking, is identified before being put to its intended use and, if it has been recognized as allowable on the basis of its marking, is treated, preferably after its intended use, in such a way that the originally detectable marking is rendered illegible.

The present invention accordingly relates to a method for preventing repeat use of a disposable article in an automatic analyzer, the disposable article being provided with a detectable marking that permits identification of the disposable article and verification of its authenticity. For identification of the disposable article in the method according to the invention, the detectable marking of the disposable article is detected by means of a suitable detection device, and the detected signal is compared with information that has been stored beforehand. If the detected signal is found to agree with the stored information, i.e. if the marking identifies the disposable article as allowable, the disposable article can be used according to its intended purpose, for example as reaction vessel. In the event that no agreement is found between the detected signal and the stored information, and the disposable article is identified as not being allowable, suitable measures are taken, for example rejection, to ensure that the disposable article is not used. To ensure that an allowed disposable article is not used more than once, the detectable marking of the disposable article is changed, removed or destroyed, such that the marking identifying the disposable article is made illegible to a detection device, i.e. non-detectable. The removal or destruction of the detectable marking takes place after the detectable marking of the disposable article has been detected and compared with the information stored beforehand. The detectable marking is preferably removed or destroyed after the disposable article has been used for its intended purpose.

The marking in question can be any detectable property that can be detected by means of a detection device and that can be removed or destroyed, preferably irreversibly.

One embodiment of the present invention relates to a method for preventing repeat use of a disposable article in an automatic analyzer, wherein the disposable article is provided with a barcode as the optoelectronically detectable marking. The disposable article can be marked with any desired type of barcode (1D, 2D or 3D code) which, for example, can be printed directly onto the disposable article or can be connected in the form of a printed adhesive label to the disposable article. The barcode is detected by means of an optically functioning data capture device. Depending on the type of barcode, the detection is effected, for example, by means of a scanner, for example on the basis of a light-sensitive semiconductor detector (CCD scanner) or, in the case of a 3D code in which color represents the third dimension, by means of a camera.

To render the barcode of the disposable article illegible, it is possible, for example, to apply a colored layer, which covers the barcode such that the bright/dark contrast is no longer sufficient for reading the barcode. Application of this additional colored layer can be effected, for example, by an inkjet printer. If the barcode is connected in the form of a printed adhesive label to the disposable article, it can also be rendered illegible by mechanical removal or destruction of the label. This can be done, for example, by scratching the label or scratching it off, for example by a metal tip guided several times across the barcode.

A further embodiment of the present invention relates to a method for preventing repeat use of a disposable article in an automatic analyzer, wherein the disposable article is provided with at least one dye as the detectable marking, which can be detected on the basis of its absorption spectrum or reflection spectrum. For this purpose, the disposable article can itself be colored with a dye or a combination of dyes, or the color marking can be connected in the form of a colored adhesive label to the disposable article. The detection of the color marking is preferably effected with the aid of a photometer, which measures the extinction or reflection dependent on the wavelength of an irradiated light beam.

To render the color marking of the disposable article illegible, it is possible, for example, to apply an additional colored layer, which covers the original color marking such that the extinction or reflection dependent on the wavelength of an irradiated light beam no longer agrees with the absorption spectrum or reflection spectrum of the original color marking. If, for example, a transparent plastic cuvette is checked by a photometer at a wavelength λ1, the extinction E₁ is expected. The cuvette is accepted if the measured value lies in the range of values of E₁−ΔE to E₁+ΔE, where ΔE corresponds to an acceptable deviation. After the cuvette is used, an additional pigment layer is applied which, at the wavelength λ₁, generates an additional extinction of >2 ΔE. On renewed checking, there would be a total extinction of >(E1+2 ΔE); this would lie outside the acceptable range of values, such that the cuvette would not be accepted for a further use. If, for example, a cuvette marked by a colored and non-transparent adhesive label is checked, by light of a specific intensity being irradiated onto the label and the reflected light being measured by a sensor, a specific desired value is expected for the reflected light, for example 30% of the intensity of the irradiated light. The cuvette is accepted if the measured reflection lies in a predetermined acceptance range, for example between 20% and 40%. After use of the cuvette, an additional pigment layer is applied to the colored label, which changes the reflection behavior such that the reflection lies outside the acceptance range. On renewed checking, there would therefore be a non-acceptable reflection, such that the cuvette would not be permitted for use a second time.

This additional colored layer can be applied by an inject printer, for example. If the color marking is connected in the form of a printed adhesive label to the disposable article, it too can be rendered illegible by a mechanical removal or destruction of the label. This can be done, for example, by scratching the marking or scratching it off, using a metal tip that is guided several times across the color marking.

A further embodiment of the present invention relates to a method for preventing repeat use of a disposable article in an automatic analyzer, wherein the disposable article is provided with a radiofrequency transponder comprising a microchip with stored information and an antenna and serving as the detectable marking (also radiofrequency identification or RFID). The information stored on the microchip is emitted as radio radiation via the antenna. The radio radiation is preferably detected by means of a reader device by inductive or capacitive coupling. To render the information stored on the microchip illegible to a suitable detection device, it is possible, for example, for the antenna of the radiofrequency transponder to be mechanically destroyed or mechanically separated from the microchip, for example by guiding a metal tip or blade across the conductor track that connects antenna and microchip.

The present invention further relates to an analyzer for automatically carrying out a method for qualitative or quantitative determination of an analyte, said analyzer being designed such that it is also suitable for carrying out the inventive method for preventing repeat use of a disposable article. For this purpose, an analyzer according to the invention contains a device for detecting a detectable marking of a disposable article, and a device for changing, removing or destroying the detectable marking of the disposable article. The detection device can, for example, be a photometer, a barcode scanner or the like. The device for changing, removing or destroying the detectable marking of the disposable article can be an inkjet printer, for example, or a movable or stationary device, such as an arm, on whose distal end a sharp and preferably metal tip or blade is mounted that acts mechanically on the detectable marking of the disposable article and thus renders it illegible. The mechanical action can be obtained either by movement of the device or by the disposable article being guided past the stationary device in such a way that sufficient contact is made for removing or destroying it.

To illustrate the invention, the method according to the invention is described below using the example of a plastic cuvette marked with a barcode:

On a plastic cuvette that is to be used just once in an automatic coagulation analyzer, the manufacturer has printed a barcode on the upper edge of the cuvette, which barcode contains information concerning the batch number and the expiry date of the cuvette. Acceptable batch numbers of cuvettes and their expiry dates are stored electronically on a storage medium in the coagulation analyzer. An operator inserts the cuvette into the cuvette support of the coagulation analyzer. An automatic transporting device removes the cuvette from the cuvette support and transports it to a first position at which a barcode scanner is mounted in such a way that it can read the barcode at the upper edge of the cuvette. The scanned information is compared with the electronically stored information:

If no barcode is present, or if the barcode is illegible, such that no information at all can be obtained that could be compared with the stored information, the cuvette is not accepted for carrying out a measurement and is transferred via a first transport path into a waste container.

If a legible barcode is present, but the scanned batch number is not stored as an acceptable batch number in the analyzer, the cuvette is not accepted for carrying out a measurement and is transferred via a first transport path into a waste container. The same procedure is followed if the scanned expiry date of the cuvette has elapsed.

If the scanned batch number is stored as an acceptable batch number in the analyzer, and if in addition the scanned expiry date of the cuvette has not yet elapsed, the cuvette is accepted for carrying out a measurement and is transferred via a second transport path to a next position, in which a sample aliquot is introduced into the cuvette using a pipetting device. The cuvette is now moved along the second transport path to a next position, in which a defined amount of reagent is introduced into the cuvette using a pipetting device, by which means the sample is mixed with the reagent. After the necessary reaction time, the cuvette is moved further along the second transport path to a next position, in which the measurement of the reaction is carried out. If, for example, it is an optically measurable reaction, the measurement is carried out with the aid of a photometer. Once the measurement of the reaction has been completed, the cuvette is moved along the second transport path to a next position, in which the barcode is destroyed by scratching it with a metal tip and thus rendered illegible. The scratching is done by stopping the cuvette in a position in which a horizontally movable arm, on whose distal end a metal tip is mounted, scratches several times across the upper edge of the cuvette, where the barcode is applied. Thereafter, the cuvette is transferred along the second transport path into a waste container.

1. A method for preventing repeat use of a disposable article in an automatic analyzer, the disposable article being provided with a detectable marker, and the method comprising the following method steps:
detecting the detectable marker of the disposable article by means of a detection device, the detection device receiving identifying information of the disposable article;
comparing the identifying information with stored information;
if the identifying information concurs with the stored information, using the disposable article in the automatic analyzer; and
rendering the detectable marker of the disposable article non-functional.

2. The method as claimed in claim 1, wherein detecting the detectable marker includes detecting a barcode marker, and wherein the detecting is effected by means of an optically functioning data capture device.

3. The method as claimed in claim 2, wherein the rendering is effected by application of a covering substance to the barcode marker.

4. The method as claimed in claim 2, wherein the rendering is effected by mechanical distortion of the barcode marker.

5. The method as claimed in claim 1, wherein detecting the detectable marker includes detecting at least one dye, and wherein the detecting is effected by means of a photometer.

6. The method as claimed in claim 5, wherein the at least one dye forms a colored portion of the disposable article.

7. The method as claimed in claim 5, wherein the at least one dye includes a colored adhesive label on the disposable article.

8. The method as claimed in claim 5, wherein the rendering is effected by application of a covering substance to the at least one dye.

9. The method as claimed in claim 7, wherein the rendering is effected by mechanical distortion of the at least one dye.

10. The method as claimed in claim 1, wherein detecting the detectable marker includes detecting a signal from a radiofrequency transponder comprising a microchip with stored information and an antenna, and wherein the detecting is effected by means of a receiving device using one of an inductive and a capacitive coupling.

11. The method as claimed in claim 10, wherein rendering is effected by one of mechanical destruction of the antenna and mechanical separation of the antenna from the microchip.

12. A system for preventing repeat use of a disposable article in an automatic analyzer, the disposable article being provided with a detectable marker, the system comprising:
a detection device for detecting the detectable marker of the disposable article; and
an alteration device for changing, removing or destroying the detectable marker of the disposable article.

13. The system of claim 12, wherein the detectable marker comprises a barcode marker, and wherein the detection device is an optically functioning data capture device.

14. The system of claim 12, wherein the detectable marker comprises at least one dye, and wherein the detection device is a photometer.

15. The system of claim 14, wherein the at least one dye comprises one of a colored portion of the disposable article and a colored label on the disposable article.

16. The system of claim 12, wherein the detectable marker comprises a radiofrequency transponder comprising a microchip with stored information and an antenna and wherein the detection device is a reader using one of an inductive and a capacitive coupling.

17. The system of claim 12, wherein the alteration device is an applicator configured to apply a covering substance to the detectable marker.

18. The system of claim 12, wherein the alteration device comprises an element configured to distort the detectable marker.

19. The system of claim 12, wherein the system further comprises a mixing device for combining an analyte and a reagent.

20. The system of claim 12, wherein the system further comprises a transport device for transporting at least one disposable article.

21. The system of claim 12, wherein the system includes a measuring device for measuring a physical parameter of the contents of at least one disposable article.

22. The system of claim 12, wherein the disposable article is one of a cuvette, a cuvette rotor, and a microtitration plate.
